(19) United States
(12) Patent Application Publication
(10) Pub. No.: US 2019/0207306 A1
(43) Pub. Date: Jul. 4, 2019

(54) De-Tuning Resistant Antenna Device

(71) Applicant: Antenova Limited, Hatfield (GB)

(72) Inventor: Chris TOMLIN, Hertforshsire (GB)

(21) Appl. No.: 16/329,655

(22) PCT Filed: Aug. 25, 2017
(86) PCT No.: PCT/GB2017/052501

§ 371 Date: Feb. 28, 2019

(30) Foreign Application Priority Data
Sep. 6, 2016 (GB) 1615108.6
May 30, 2017 (GB) 1708575.4

(51) Int. Cl. H01Q 1/52; H01Q 9/04

(52) U.S. Cl. CPC H01Q 1/52; H01Q 9/045

(57) ABSTRACT

An antenna device including an electrically conductive base layer (10), a non-conductive support (12) disposed directly over the base layer, and an antenna layer (20) is provided. The antenna layer includes an electrically conductive antenna element (28) and an electrical connection point (26) for connecting the antenna to a port. The antenna layer is disposed directly over the non-conductive support, such that the support electrically isolates the base layer from the antenna layer, and such that the base layer provides radio frequency shielding to the antenna layer. The antenna device further includes an electrically insulating element (14) configured to insulate the base layer from a host surface.

This invention relates to an antenna device that is adapted so that it is operable on a variety of types of surfaces or materials. Certain embodiments provide an antenna assembly and antenna device compatible for use with multiple different materials allowing the antenna device to operate on any required material while remaining in tune at the correct or desired frequency or frequencies. In some embodiments, the antenna device is a single or a multiple band de-tuning resistant antenna device.

### BACKGROUND

With the rapid expansion of the market for telecommunications devices, especially in the machine-to-machine (M2M) or “Internet of Things” sector, and the development of different communications protocols, including WiFi, 4G, LTE etc., many devices require multiple internal antennas covering a wide range of user frequencies. These often need to be incorporated into telecommunication devices in a compact and space efficient manner. This means that design-in times are extended and radio frequency (RF) problems increased. Antenna devices and applications today require a secure robust housing to enable desired applications in harsh environments or uses. However, keeping the antenna functional in harsh environments is challenging and is a compromise between signal loss or poor performance and increasing antenna robustness. It would be desirable to have an antenna device being sufficiently robust and being resistant to de-tuning on different surfaces to ease incorporation of antenna devices within telecommunication and global positioning devices without significantly impacting the RF performance of the antenna device.

### BRIEF SUMMARY OF THE DISCLOSURE

According to a first aspect of the present invention, there is provided an antenna device comprising:
an electrically conductive base layer;
a non-conductive support disposed directly over the base layer;
an antenna layer comprising an electrically conductive antenna element and an electrical connection point for connecting the antenna to a port, wherein the antenna layer is disposed directly over the non-conductive support, such that the support electrically isolates the base layer from the antenna layer, and such that the base layer provides radio frequency shielding to the antenna layer; and
an electrically insulating element configured to insulate the base layer from a host surface.

The base layer and the non-conductive support may be provided as a laminate structure comprising the base layer and the non-conductive support.

Suitably, the base layer, the non-conductive support and the electrically insulating element are provided as a laminate structure comprising the base layer, the non-conductive support and the electrically insulating element.

Suitably, the non-conductive support comprises at least one dielectric layer to separate the base layer from the antenna of the antenna layer.

Suitably, the electrically insulating element comprises a non-conductive coating over the base layer.

Suitably, the non-conductive support and the electrically insulating element comprise a non-conductive coating substantially encapsulating the base layer.

Suitably, the non-conductive coating comprises a laminate material.

Suitably, the antenna element comprises an electrically conductive track comprising an asymmetrical element having a capacitive feed, wherein the asymmetrical element is configured to provide resonance.

Suitably, the antenna device of any preceding claim, wherein the antenna element is a single frequency band antenna.

Suitably, the antenna element is a multi-frequency band antenna.

Suitably, the electrical connection point is configured as a pin extending from the antenna layer.

Suitably, the electrical connection point is configured as surface mount pad.

Suitably, the base layer and the antenna layer are substantially parallel to each other.

Suitably, the electrically insulating element is configured as a further non-conductive support disposed under the base layer, and the antenna device further comprises a further antenna layer disposed directly under the further non-conductive support.

Suitably, the further non-conductive support is disposed directly under the base layer.

Suitably, the antenna device further comprises at least one conductive layer between the base layer and the further non-conductive support.

Suitably, the antenna device further comprises at least one insulating layer between the base layer and further non-conductive support.

Viewed from another aspect, there is provided an antenna device comprising a first, electrically conductive base layer, and a second layer comprising an electrically conductive track and an electrical connection point for connecting the electrically conductive track to a port; wherein the second layer is disposed over the first layer, the first layer being electrically isolated from the second layer, such that the first layer provides radio frequency shielding to the second layer.

Advantageously, the antenna device maintains a desired tuning irrespective of the antenna device position on a host surface. For example, the tuning of the antenna device when the antenna device is in free space may be substantially the same as when the antenna device is placed on a metallic host surface. This is because the first layer isolates the second layer from the host surface and provides shielding. Additionally, the first layer may help to steer radiation patterns generated by the antenna device away from the host surface. The second layer is immune to electromagnetic coupling to any other surface below the first layer and does not rely on any interaction of any other layer beneath the first layer.

Preferably, the first layer may have a laminate structure, comprising a conductive base layer and at least one dielectric layer to separate the base layer from the electrically conductive track of the second layer.

Optionally, the first layer is provided with a non-conductive coating. A standard generic type of soldermask may be used as the non-conductive coating.

Preferably, the non-conductive coating may substantially encapsulate the first layer.

Preferably, the non-conductive coating comprises a laminate material.

The electrically conductive track may comprise an asymmetrical element having a capacitive feed. The asymmetrical element may provide resonance.

Preferably, the electrical connection point may be configured as a pin extending from the second layer.

Alternatively, the electrical connection point may be configured as surface mount pad.

The first layer and the second layers may be arranged so that they are substantially parallel to each other.

Optionally, the electrical conductive track is a single frequency band antenna track.

Alternatively, the electrical conductive track is a multi-frequency band antenna track.

### BRIEF DESCRIPTION OF THE DRAWINGS

Embodiments of the invention are further described hereinafter with reference to the accompanying drawings, in which:

FIGS. 1 to 3 are schematic views of a first embodiment;

FIG. 4 shows the return loss for an antenna device according to a first embodiment, wherein the antenna is tuned for a global navigation satellite system having a frequency 1559-1609 MHz;

FIGS. 5 and 6 illustrates a schematic view of another example of an antenna device; and

FIG. 7 illustrates yet another example of an antenna device.

### DETAILED DESCRIPTION

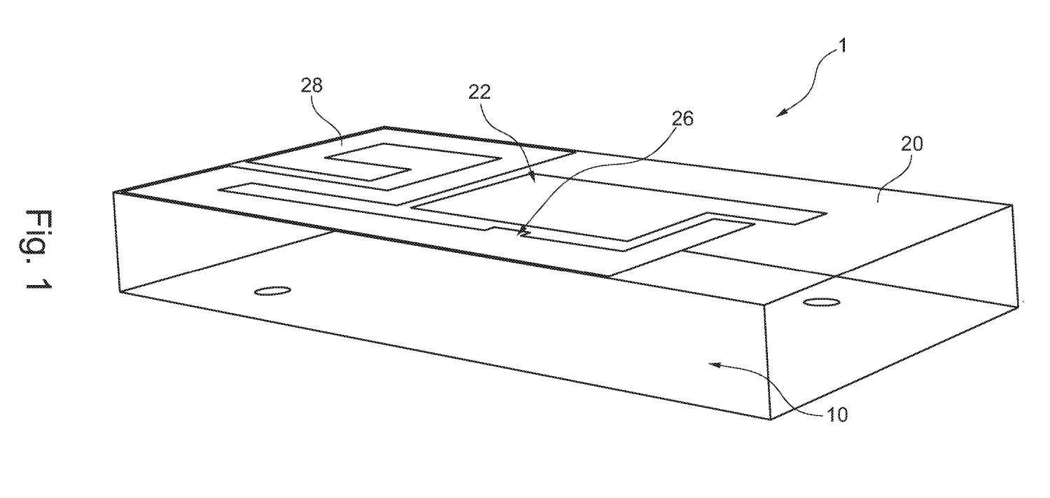

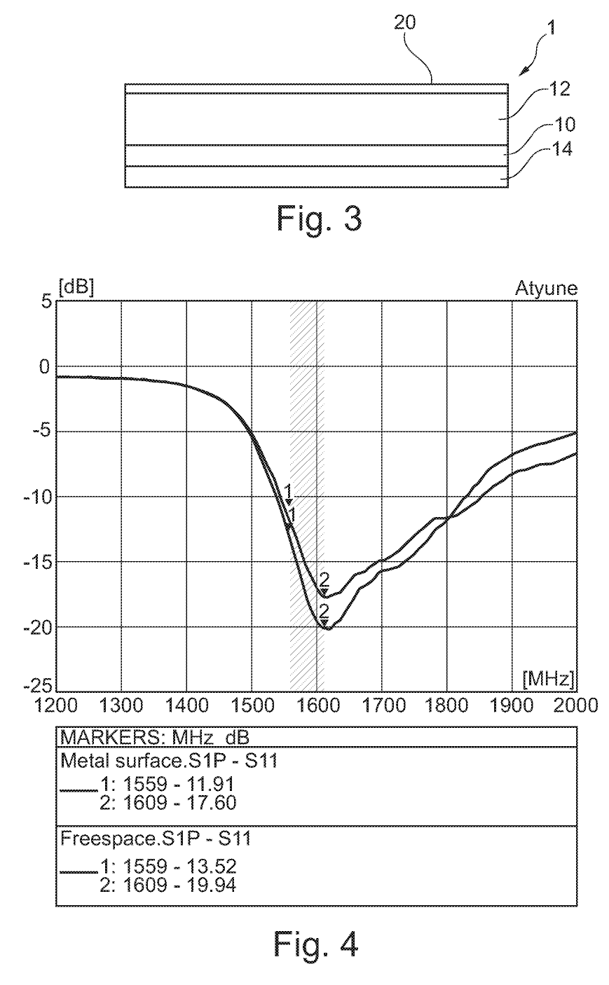

FIGS. 1 to 3 show an exemplary embodiment of an antenna device 1. The antenna device 1 includes a first layer 10 such as a conductive base layer.

The antenna device 1 also includes a second layer 20 such as an antenna element top layer (i.e. an antenna layer). The antenna device 1 is a multilayer structure. The first base layer 10 and the second antenna layer 20 are arranged in a substantially parallel arrangement.

In one example, the first 10 and second 20 layers are separated by a space 12 or a non-conductive support, for example a laminate layer. The space 12 is exaggerated in FIGS. 1 to 3 for illustrative purposes. The non-conductive support 12 electrically isolates the first base layer 10 from the second antenna layer 20. The non-conductive support 12 is disposed directly over the first base layer 10 such that a first surface of the non-conductive support 12 contacts the first base layer 10. In other words the non-conductive support 12 is disposed directly adjacent the first base layer 10.

The second antenna layer 20 is disposed directly over the non-conductive support 12 such that a second surface of the non-conductive support 12 contacts the second antenna layer 20. In other words the non-conductive support 12 is disposed directly adjacent the second antenna layer 20.

The non-conductive support 12 may be of any suitable form for electrically isolating the first base layer 10 from the second antenna layer 20. For example, the non-conductive support 12 may be a continuous layer extending over the whole surface of the first base layer 10, or may be in the form of a plurality of discrete pads that function to mechanically separate the base layer 10 from the antenna layer 20 and thus electrically isolate them. In other examples the non-conductive support 12 may be a non-conducting coating over the base layer. The non-conductive support 12 may be of any suitable insulating material, for example, a dielectric material, a polymer material or a laminate material. In some examples, the non-conductive support 12 may include multiple layers, each of non-conductive insulating material.

The antenna device 1 further includes an electrically insulating element 14 for insulating the base layer from a host surface. A host surface may be any surface upon which the antenna device 1 is intended to be positioned or supported. Typically, the host surface may be part of a device in which the antenna device 1 is to be installed. The electrically insulating element 14 may extend over a bottom surface of the base layer 10, distal from the antenna layer 20. The electrically insulating element 14 may be in the form of a non-conductive layer disposed over the bottom surface of the base layer 10. In other examples, the electrically insulating element 14 may be a non-conductive coating over the bottom surface of the base layer 10.

The multilayer structure is such that the first base layer 10 provides radio frequency shielding to the second antenna layer 20. The first layer 10 is galvanically isolated from the second layer 20 thereby reducing any impact of a host surface such as a metallic surface on the RF characteristics of the antenna track on the second surface. The first layer 10 remains galvanically isolated and independent from the second layer 20 and also remains galvanically isolated and independent from the host surface it is to be placed upon, such as a metallic host surface (not shown).

The first layer 10 is an electrically conductive base layer. The first base layer 10 is aptly large enough to cover at least the surface area occupied by the antenna in the second antenna layer 20. That is, the surface area of the base layer 10 should be at least the size of the whole area of the antenna. In this way, the first base layer 10 can operate to shield the entire antenna. The base layer 10 may be a sheet of conductive material, for example a copper foil. Aptly, the base layer 10 extends continuously over the whole of the layer (i.e. without any gaps or holes), to help prevent any interference with the antenna from host surfaces.

In one example, the first base layer 10 and the non-conductive support 14 may be part of a laminate structure. In another example, the first base layer, the non-conductive support and the electrically insulating element may be part of a single laminate structure.

In one example, both the support layer 12 and the electrically insulating element 14 may comprise a non-conductive coating substantially encapsulating the first base layer 10.

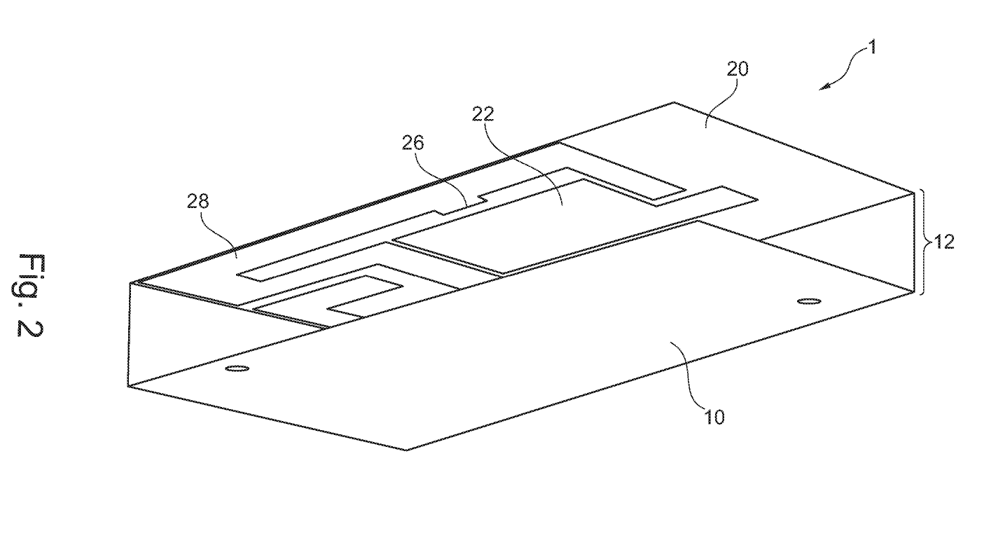

The second layer 20 comprises an antenna element in the form of an electrical conductive track 28 and an electrical connection point 26 for connecting the electrical conductive track 28 to a port. The electrical connection point 26 is for a feed connector (e.g. for connection to a signal feed). Optionally, a parasitic antenna portion 22 is provided. As can be seen in FIGS. 1 and 2, the first layer 10 and the second layer 20 are disposed substantially on top of each other, in a parallel arrangement.

The first layer 10 is galvanically isolated from the second layer 20. Isolating the first layer 10 from the second layer 20 provides the advantage that the first layer 10 provides shielding to the second layer 20 and allows the antenna device 1 to be used on a variety of different surfaces, including metallic surfaces which would normally adversely impact the tuning of the antenna device 1.

The second layer 20 contains the antenna element structure. The feed is connected to the electrical connector 26 by a cable that connects to the host printed circuit board (PCB) radio frequency (RF) port (not shown). The first layer 10 is configured to provide beam steering i.e. the first layer may help to steer radiation patterns generated by the antenna device away from the host surface. Furthermore, the first layer provides shielding from the host surface of a host device. This ensures the antenna device will remain on tune when adhered to any other host surface material.

FIG. 4 shows the return loss of an example of an antenna device 1. This particular antenna is tuned as a global navigation satellite system antenna having a frequency range from 1559-1609 MHz.

As can been seen from FIG. 4, the tuning of the antenna device 1 is essentially unchanged when the antenna device is tested in free space and when the antenna device 1 is placed upon a metallic surface. The antenna device 1 shows remarkable tuning resistance on different surfaces because the first layer 10 shields the second layer 20 from the host surface such as a metallic surface and provides beam steering from the host surface.

In one example, the antenna element is a single band antenna. In another example, the antenna element is a multiband antenna.

In an example, the non-conductive coating is a standard generic type of soldermask. One example of a standard generic type of soldermask is Imagecure XV501T-4, from Sun Chemical Corporation. Another type of suitable soldermask coating may be a combination of Probimer 77/9000 resin and Hardener 77/9002 mixed in a ratio of 2.4 g resin to 0.4 g hardener.

In another example, the non-conducting coating further includes a laminate structure such as a glass-reinforced epoxy laminate sheet or printed circuit board substrate such as but not limited to, FR4 or Duroid.

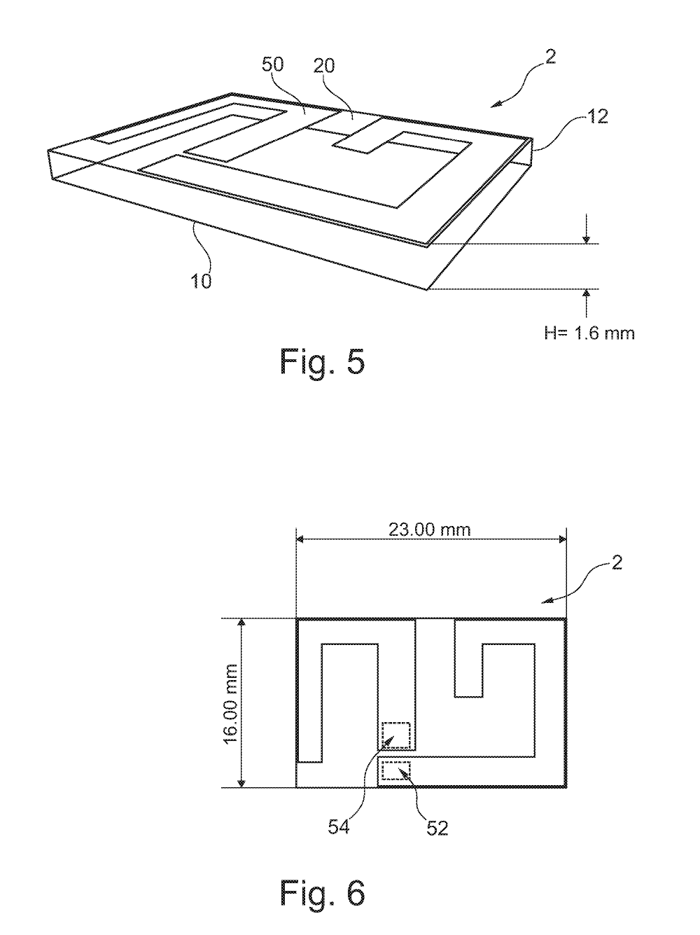

FIGS. 5 and 6 illustrate another example of an antenna device 2. The antenna device 2 may be configured similarly to the antenna device 1 of FIGS. 1 to 3 having a base layer 10, a support 12, an antenna layer 20, and an electrically insulating element 14. However, in this example, the antenna layer 20 has a different antenna configuration.

In this example, the antenna layer includes a folded dipole antenna structure 50 with asymmetrical radiating arms (i.e. arms of differing lengths) and capacitive ground. A first arm includes an antenna feed 54 and a second arm includes ground connection point 52. Due to the conductive base layer 10, the antenna structure cannot follow a ¼ wave design rule that is often used for an antenna, and therefore the radiating element wavelength is offset for each arm. The radiating arms are thus tuned for different resonances above the required frequency. This allows the antenna to coexist and correctly function with the base layer 10 at a fixed height relative to the base layer 10.

In this particular example, the antenna layer 20 is spaced apart from the base layer 10 by about 1.6 mm and the antenna layer 20 extends over an area of about 16 mm by about 23 mm. The non-conductive support 12 separates the antenna layer 20 from the base layer 10 and thus the thickness of the support 12 aptly corresponds to the required separation distance. It will be appreciated that the length of the radiating arms and the separation distance between the antenna layer and the base layer (or the thickness of the support) can be adjusted according to the desired operating frequency of the antenna device.

The isolated base layer of the above examples helps prevent interaction between any external object changing the RF characteristics of the antenna. The isolated base layer helps prevent the proximity of any host material (e.g. metal, stone, wood, plastic) from changing the RF performance. This allows the device to be used in dramatically different environments without causing any change to the desired resonance of the device.

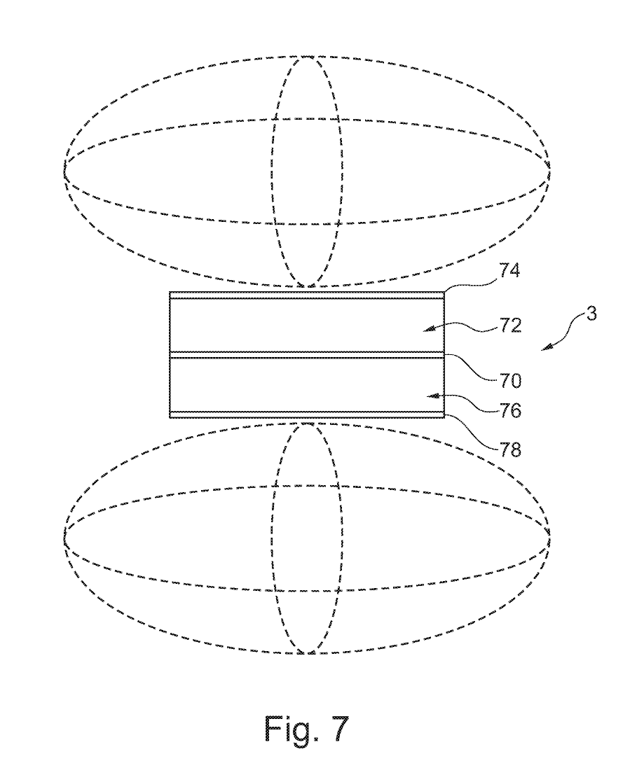

FIG. 7 illustrates a further example of an antenna device. The antenna device 3 shown in FIG. 7 includes a “back-to-back” antenna construction. This device may be useful in communication systems, for example, which often have multiple antennas (e.g. in Wi-Fi applications). Such antennas should exhibit certain specifications, for example isolation of the antennas and non-correlation of the radiation patterns. This is to reduce cross-talk between the antennas and also control beam steer in different directions to take advantage of multiple signals and multiple signal paths to enhance the speed of the connection. In known multi-antenna systems, typical isolation is about −15 dB between antennas of the same frequency band.

The example shown in FIG. 7 includes all of the component layers shown in the examples of FIGS. 1 to 3 and 5 to 6. However, in this example, the electrically insulating element 14 is configured as a further non-conductive support, which may be configured in the same way as the first non-conductive support described above. A further antenna layer is disposed directly below the further non-conductive support to form the back-to-back antenna configuration. Thus, the antenna device includes an electrically conductive base layer 70. A first non-conductive support 72 is disposed directly over the base layer 70 and a first antenna layer 74 is disposed directly over the first non-conductive support 72. A further non-conductive support 76 is disposed directly under the base layer 70, and a further antenna element 78 is disposed directly below the further non-conductive support 76. In this example, the distance between the two antenna layers 74 and 78 is about 3.2 mm.

The dotted lines show a representation of the beam patterns of the antennas working simultaneously. In this example, each of the antennas are tuned to the same frequency, but it will be appreciated that different frequency bands could also be used for each antenna.

With the example, shown in FIG. 7 an isolation between the antennas of around −35 dB was achieved with an efficiency of 65%. As such, the device has a much improved performance compared to known devices, which can typically only achieve an isolation of about −15 dB when the antennas are spaced apart by about 30 to 40 mm. Thus, the device shown in FIG. 7 can be of more compact design as well as having improved isolation performance.

Various modifications to the device of FIG. 7 may be possible. For example, the device may be configured as two of the devices of FIGS. 1 to 3 or 5 to 6 positioned in a back-to back-configuration. The devices may be adhered together using a suitable adhesive, for example. Thus, in this example, the device would include a further conductive base layer disposed over the second non-conductive support 76 and optionally at least one insulating element between the first base layer 70 and the further base layer.

Further aspects of the disclosure are described in the following numbered paragraphs:

1. An antenna device comprising a first, electrically conductive base layer, and a second layer comprising an electrically conductive track and an electrical connection point for connecting the electrically conductive track to a port; wherein the second layer is disposed over the first layer, the first layer being electrically isolated from the second layer, such that the first layer provides radio frequency shielding to the second layer.

2. The antenna device of paragraph 1, wherein the first layer is a laminate structure, comprising a conductive base layer and at least one dielectric layer to separate the base layer from the electrically conductive track of the second layer.

3. The antenna device of paragraph 1 or paragraph 2, wherein first layer is provided with a non-conductive coating.

4. The antenna device of paragraph 3, wherein the non-conductive coating substantially encapsulates the first layer.

5. The antenna device of paragraph 3 or paragraph 4, the non-conductive coating comprises a laminate material.

6. The antenna device of any of paragraphs 1 to 5, wherein the electrically conductive track is an asymmetrical element having a capacitive feed, wherein the asymmetrical element is configured to provide resonance.

7. The antenna device of any of paragraphs 1 to 6, wherein the electrically conductive track is a single frequency band antenna track.

8. The antenna device of any of paragraphs 1 to 7, wherein electrical conductive track is a multi-frequency band antenna track.

9. The antenna device of any of paragraphs 1 to 8, wherein the electrical connection point is configured as a pin extending from the second layer.

10. The antenna device of any of paragraphs 1 to 8, wherein the electrical connection point is configured as surface mount pad.

11. The antenna device of any of paragraphs 1 to 10, wherein the first layer and the second layers are substantially parallel to each other.

Throughout the description and claims of this specification, the words “comprise” and “contain” and variations of them mean “including but not limited to”, and they are not intended to (and do not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. An antenna device comprising:
an electrically conductive base layer;
a non-conductive support disposed directly over the base layer;
an antenna layer comprising:
an electrically conductive antenna element; and
an electrical connection point for connecting the antenna to a port;
wherein the antenna layer is disposed directly over the non-conductive support, such that the support electrically isolates the base layer from the antenna layer, and such that the base layer provides radio frequency shielding to the antenna layer; and
an electrically insulating element configured to insulate the base layer from a host surface.

2. The antenna device of claim 1, wherein the base layer and the non-conductive support are provided as a laminate structure comprising the base layer and the non-conductive support.

3. The antenna device of claim 1, wherein the base layer, the non-conductive support and the electrically insulating element are provided as a laminate structure comprising the base layer, the non-conductive support and the electrically insulating element.

4. The antenna device of claim 1, wherein the non-conductive support comprises at least one dielectric layer to separate the base layer from the antenna of the antenna layer.

5. The antenna device of claim 1, wherein the electrically insulating element comprises a non-conductive coating over the base layer.

6. The antenna device of claim 1, wherein the non-conductive support and the electrically insulating element comprise a non-conductive coating substantially encapsulating the base layer.

7. The antenna device of claim 5, wherein the non-conductive coating comprises a laminate material.

8. The antenna device of claim 1, wherein the antenna element comprises an electrically conductive track comprising an asymmetrical element having a capacitive feed; and
wherein the asymmetrical element is configured to provide resonance.

9. The antenna device of claim 1, wherein the antenna element is a single frequency band antenna.

10. The antenna device of claim 1, wherein the antenna element is a multi-frequency band antenna.

11. The antenna device of claim 1, wherein the electrical connection point is configured as a pin extending from the antenna layer.

12. The antenna device of claim 1, wherein the electrical connection point is configured as surface mount pad.

13. The antenna device of claim 1, wherein the base layer and the antenna layer are substantially parallel to each other.

14. The antenna device of claim 1, wherein the electrically insulating element is configured as a further non-conductive support disposed under the base layer, the antenna device further comprising a further antenna layer disposed directly under the further non-conductive support.

15. The antenna device of claim 14, wherein the further non-conductive support is disposed directly under the base layer.

16. The antenna device of claim 14 further comprising at least one conductive layer between the base layer and the further non-conductive support.

17. The antenna device of claim 14 further comprising at least one insulating layer between the base layer and further non-conductive support.

18. An antenna device comprising:
an electrically conductive base layer;
a non-conductive support disposed directly over the base layer;
an antenna layer comprising:
an electrically conductive antenna element comprising an electrically conductive track comprising an asymmetrical element configured to provide resonance and having a capacitive feed; and
an electrical connection point for connecting the antenna to a port;
wherein the antenna layer is disposed directly over the non-conductive support, such that the support electrically isolates the base layer from the antenna layer, and such that the base layer provides radio frequency shielding to the antenna layer; and
an electrically insulating element configured to insulate the base layer from a host surface;
wherein the non-conductive support comprises at least one dielectric layer to separate the base layer from the antenna of the antenna layer;
wherein the electrical connection point is selected from the group consisting of a pin extending from the antenna layer and a surface mount pad; and
wherein the base layer and the antenna layer are substantially parallel to each other.

19. The antenna device of claim 18, wherein the non-conductive support and the electrically insulating element comprise a non-conductive coating of a laminate material substantially encapsulating the base layer.

20. The antenna device of claim 18 further comprising:
a further antenna layer;
a conductive layer; and
an insulating layer;
wherein the electrically insulating element is configured as a further non-conductive support disposed directly under the base layer;
wherein the further antenna layer is disposed directly under the further non-conductive support;
wherein the conductive layer is positioned between the base layer and the further non-conductive support; and
wherein the insulating layer is positioned between the base layer and the further non-conductive support.
